(19) United States
(12) Patent Application Publication
(10) Pub. No.: US 2026/0004298 A1
(43) Pub. Date: Jan. 1, 2026

(54) RELATIONSHIP IDENTIFICATION AMONG RECORDS

(71) Applicant: MASTERCARD INTERNATIONAL INCORPORATED, PURCHASE, NY (US)

(72) Inventors: Sai Abhishek Sara, Hyderabad (IN); Alok Singh, Gurgaon (IN); Bhanupriya Pegu, Dhemaji (IN); Maneet Singh, New Delhi (IN); Tarun Somavarapu, Hyderabad (IN)

(21) Appl. No.: 18/757,480

(22) Filed: Jun. 27, 2024

(51) Int. Cl. G06Q 20/40; G06Q 20/22; G06Q 30/018

(52) U.S. Cl. CPC G06Q 20/4016; G06Q 20/227; G06Q 30/0185

(57) ABSTRACT

Examples include a system that identifies relationships between records. Data corresponding to a plurality of records is accessed, wherein the data is related to different consumer cards. Data fields of the data are compared to identify one or more matches between the plurality of records. A plurality of relationships between the plurality of records is determined based at least on the identified one or more matches. A score is generated based on the determined plurality of relationships. The system produces risk assessment data with enhanced reliability and greater accuracy while reducing system resource usage.

### BACKGROUND

Payment cards or payment accounts can be associated with different entities (e.g., different users). Capturing behavior-based analytics corresponding to the payment cards or payment accounts can be helpful to identify different types of risks, such as fraud risk and return risk, as well as identify different opportunities or recommendations for other applications. However, a full view of entity behavior (e.g., cardholder behavior), including accurately identifying and understanding the relationships between different records of these payment cards or payment accounts, can be difficult to ascertain, such as when a user has multiple payment cards or payment accounts, or a single payment card or payment account is shared by a group (e.g., family members).

### SUMMARY

Some examples provide a system and a method for identifying relationships between records. One implementation includes accessing data corresponding to a plurality of records, wherein the data is related to different consumer cards. Data fields of the data are compared to identify one or more matches between the plurality of records, wherein the one or more matches comprises a locality match, a shipping address match, an email match, a device match, or a combination thereof. A plurality of relationships between the plurality of records is determined based at least on the identified one or more matches. A score based on the determined plurality of relationships is generated and presented via a user interface device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for identifying relationships between records.

FIG. 2 is an exemplary block diagram illustrating a network of payment types formed using identified relationships.

FIG. 3 is an exemplary table illustrating relationship levels associated with a fraud connected analysis.

FIG. 4 is an exemplary flow chart illustrating operations of a computing device to identify relationships between records.

FIG. 5 is an exemplary block diagram illustrating connections between a single cardholder and multiple payment cards.

FIG. 6 is an exemplary block diagram illustrating different levels of relationships of users of payments cards.

FIG. 7 is an exemplary flow chart illustrating operations of a computing device to monitor for risk.

FIG. 8 illustrates a computing apparatus according to an embodiment as a functional block diagram.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Although payment card or payment account data can provide information useful for fraud risk, return risk, bust out risk, affluence scoring, etc., data management and analysis of the information can be challenging. For example, accurately identifying and understanding the relationships between different records related to payment cards and/or payment accounts can be difficult. These records, such as related to consumer cards, contain useful data that, if accurately analyzed, can provide valuable insights into consumer behavior, risk assessment, and more. However, the volume and complexity of this data can make it difficult to effectively compare and analyze the records, such as when the records correspond to multiple payment cards and/or payment accounts or are shared by multiple users.

Referring to the figures, examples of the disclosure identify relationships between the payment cards and/or payment accounts to facilitate providing insights into consumer behavior, risk assessment, and more. One or more systems and methods efficiently and accurately identify one or more different levels of relationships between payment cards and/or payment accounts, such as payment cards for the same user, friends and family, same locality, etc. Useful information is provided to downstream applications, such as for affluence scoring, fraud detection, loyalty, etc. In one or more examples, a network of payment cards and/or payment accounts is formed using data (e.g., 3-D Secure 2.0 (3DS2) data) from different data fields.

Aspects of the disclosure enable technologically efficient and effective analysis of data related to payment cards and/or payment accounts to identify matches between records, including matches based on various data fields of the records, for example, locality, shipping address, email address, device information, or other payment account information. In one or more examples, the representation of the relationships between the payment cards and/or payment accounts in a comprehensible manner allows for extracting one or more networks (e.g., account network, device network, billing address network, location network, etc.) of payment cards and/or payment accounts with different entities to produce meaningful insights for the digital identity of one or more cardholders or account holders.

In various examples, the one or more networks allow for consideration of the dynamic nature of consumer data and efficiently handles the associated layers of complexity. For example, consumer records are constantly changing and evolving, which can result in relationships identified between records quickly becoming outdated. With one or more systems and methods described herein, relationships between records are accurately identified and represented, which also adapts to changes in the data over time.

In some examples, scores or other quantitative measures are used to represent relationships that are in common or have a relationship. That is, one or more examples generate task specific scores that provide details to fully understand the relationships between records of the payment cards and/or payment accounts that can be used for downstream applications as described in more detail herein. The application of these insights in a practical context, such as risk assessment or fraud detection, is provided by one or more examples that generate a score based on the identified relationships, and also transmits this score to the one or more downstream applications or systems for further analysis and action. As a result, a more effective and dynamic method for identifying, representing, and applying the relationships between consumer records in the field of data management and analysis is provided. In some examples, more efficient and reliable information is thereby provided to the downstream applications or systems, which also results in improved risk detection, reporting, scoring, etc., as well as an improved user (e.g., consumer) experience.

Aspects of the disclosure address the herein described technical problems by improving the data used for different applications based on the identified relationships between records of the payment cards and/or payment accounts. One or more technical effects provided by identifying relationships between records determined from comparing data fields to identify one or more matches (e.g., one or more of a locality match, a shipping address match, an email match, a device match, or a combination thereof) include one or more of a reduced processor load, less memory space required, reduced hardware requirements, enhanced reliability, and improvements in user interaction (such as improved usability, improved user efficiency, and increased user interaction performance).

Other examples provide representations (e.g., graphical representations, such as icons) associated with the records that enables a user to quickly assess the relationships between the different payment cards and/or payment accounts, in a user interface (UI). This improves user efficiency via the UI interaction and improves user performance via the UI.

In various aspects, a computing device operates in an unconventional manner by identifying relationships between payment cards and/or payment accounts using data fields to determine matches from a large amount of data. In this manner, the computing device is used in an unconventional way, and allows a user with data related to many different records for many different entities to efficiently and accurately obtain reliable relationship information for different payment cards and/or payment accounts, thereby improving the functioning of the underlying computing device while reducing system resource usage. In some examples, the user is likely to issue a lesser number of commands to the computing device for monitoring the relationship between payment cards and/or payment accounts. The lesser number of commands to the computing device results in reduced system resource usage.

Further, aspects of the disclosure improve the usability of the records data and/or the underlying device at least by generating a score based on the relationships. Efficiency is also improved via display of the data showing the relationships, and user interaction performance is also improved via the UIs as described herein. This overall improves the human machine interaction.

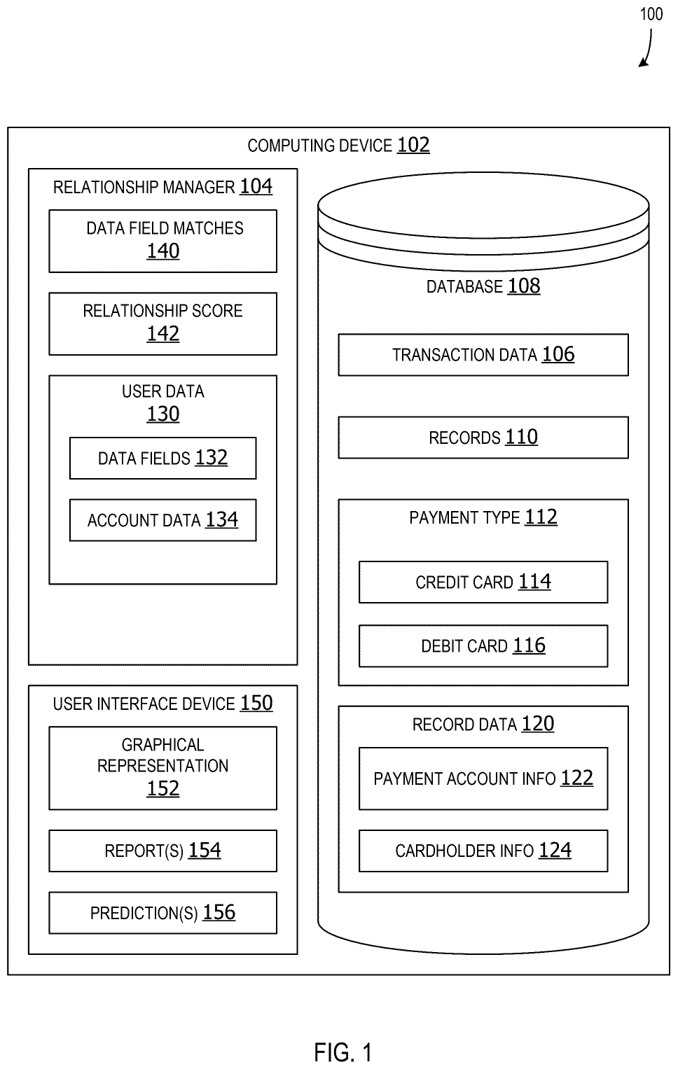

Referring to the figures, and in particular FIG. 1, an exemplary block diagram illustrates a system 100 for identifying relationships between records, such as relationships payment cards and/or payment accounts, using credit-related transaction data. In the example of FIG. 1, the system 100 includes a computing device 102 that represents any type of computing device executing instructions, such as application programs, operating system functionality, or both. The computing device 102, in some examples, includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the application programs include a relationship manager 104. The relationship manager 104 in some examples accesses transaction data 106 (corresponding to records 110) on a data store, such as, but not limited to, a database 108. The transaction data 106 and corresponding records 110 describe retail sales or transactions completed using a payment type 112 (associated with one or more users), which may be within a geographic area. The records 110 are associated with record data 120 that includes payment account information 122 and cardholder information 124. For example, the payment account information 122 can include information or data related to one or more of: card used in same account with 3DS requestor, billing/shipping zip code, city, state and country, internet protocol (IP) information, device information, device channel, and browser language, among others.

The payment type 112 includes different types of payments, such as payment using a credit card 114 or a debit card 116. That is, the payment type 112 is a credit-related payment type that includes transaction data for transactions completed using credit card 114 and/or the debit card 116 payment methods. In this example, the transaction data 106 includes payment data for different credit card 114 and/or the debit card 116 payments that are associated with one or more cardholders.

The relationship manager 104 in some examples obtains user data 130 associated with or corresponding to the records 110. The user data 130 includes data obtained from one or more data fields 132, such as 3DS or 3DS2 data fields associated with one or more cardholders corresponding to the payment types 112. In some examples, the data fields 132 include account data 134, such as 3DS client data fields having data corresponding to at least one or more of the following:
(1) Browser information: IP Address, height, width, language and color depth, Time Zone;
(2) Billing and shipping address ZIP, city, state, country;
(3) Device information—device channel, operating system, device model, system language, system time zone, etc.; and
(4) Cardholder name, phone, email address.

It should be noted that the user data 130 can be any type of data associated with the cardholder, payment type 112, record data 120, etc.

In some examples, the relationship manager 104 identifies or more data field matches 140 by comparing the user data 130. For example, the data fields 132 of the user data 130 are compared to identify one or more matches between the plurality of records 110 (e.g., the same or similar account data or client data for the data fields in different records). The matches can include different types of matches, such as a locality match, a shipping address match, an email match, a device match, or a combination thereof, as well as others. The data field matches 140 are used to determine relationships between the plurality of records 110. That is, relationships between the records 110 are identified based on the data field matches 140, which are used in some examples to generate a relationship score 142. For example, based on a number or type of the matches, namely the data field matches 140, a relationship level is defined, wherein more data field matches 140 between records 110 results in a higher level of the relationship (e.g., more related connection between records). As one example, shown in Table 1 below, as the number of data field matches 140 (corresponding to the check marks) increases, a level of the relationship between the records 110 increases, indicating that the records have a higher likelihood of being related (e.g., related to the same user or group of users).

TABLE 1

| | Shipping | | | |
|---|---|---|---|---|
| Locality | address | Email | Device | Relationship |
| match | match | match | match | inferred |
| ✓ | X | X | X | Level 0 |
| ✓ | ✓ | X | X | Level 1 |
| ✓ | ✓ | ✓ | ✓ | Level 2 |

As can be seen in Table 1, showing four different data fields 132, one match between the data fields 132 defines a Level 0 relationship, two matches between the data fields 132 defines a Level 1 relationship and four matches between the data fields 132 defines a Level 2 relationship. As such, the relationship level in some examples infers a strength or likelihood of the relationship. It should be noted that different criteria (such as the number or type of matches) can be used to define the different relationship levels. That is, the criteria used to define the different levels can be varied as described or needed.

The relationship manager 104 in some examples calculates the relationship score 142 using the data field matches 140 and the determined relationship levels. In one particular example, the relationship score 142 (scoreₑ) is calculated using the following equation:

$${score}_{u} = f ( \begin{matrix}{f}_{level 2} ( \{ {score}_{v} : v ∈ {𝒩}_{u}^{level 0} \} ) , \\ {f}_{level 1} ( \{ {score}_{v} : v ∈ {𝒩}_{u}^{level 1} \} ) , \\ {f}_{level 2} ( \{ {score}_{v} : v ∈ {𝒩}_{u}^{level 2} \} )\end{matrix} )$$

In some examples, the relationship score 142 represent a task specific score. That is, the relationship score 142 is a score related to task to be performed and is transmitted to a downstream application (e.g., fraud detection application or loyalty application) in one or more examples. In some examples, the relationship score 142 is thereby generated or calculated based on one or more relationships between the records 110 with the relationship score 142 compared to a threshold value to determine the transmission of the score to the downstream application. It should be noted that the task to be performed can be any credit related or payment related task, such as related to fraud risk, return risk, affluence score, bust out risk, etc. In some examples, the relationship score 142 is used as part of a connected intelligence for the different records 110 to perform different actions, operations, or analysis.

Thus, in various examples, the relationship score 142 can be determined or calculated using a scoring function and then used for a particular scoring scheme. A message passing algorithm is used as the scoring function in some examples. However, any suitable scoring function can be used, such as based on the type of application. An example of a scoring scheme for fraud risk is as follows:
(1) Initialize the scores with fraud ratio/fraud count of each card;
(2) f->mean; and
(3) Score of each payment type 112 (e.g., credit card 114) gives a view of the risk associated with the other connected payment types 112.

In the example scoring scheme above, the function “f” is chosen to be the “mean” or “average” function which takes the simple/weighted average of the scores of the neighboring cards.

In some aspects, the relationship manager 104 is configured to identify the data field matches 140 corresponding to a desired or required relationship determination. That is, the relationship manager 104 is operable to determine different types of relationships between, for example, the payment types 112 corresponding to a desired or required task, including, but not limited to: credit bust-out, reporting cards that are likely to bust-out to issuers, leaked card reporting, report cards that are likely to have been leaked to issuers, fraud risk, features for downstream fraud detection models, return risk, report cards that are likely to return to merchants, and marketing and loyalty, among others.

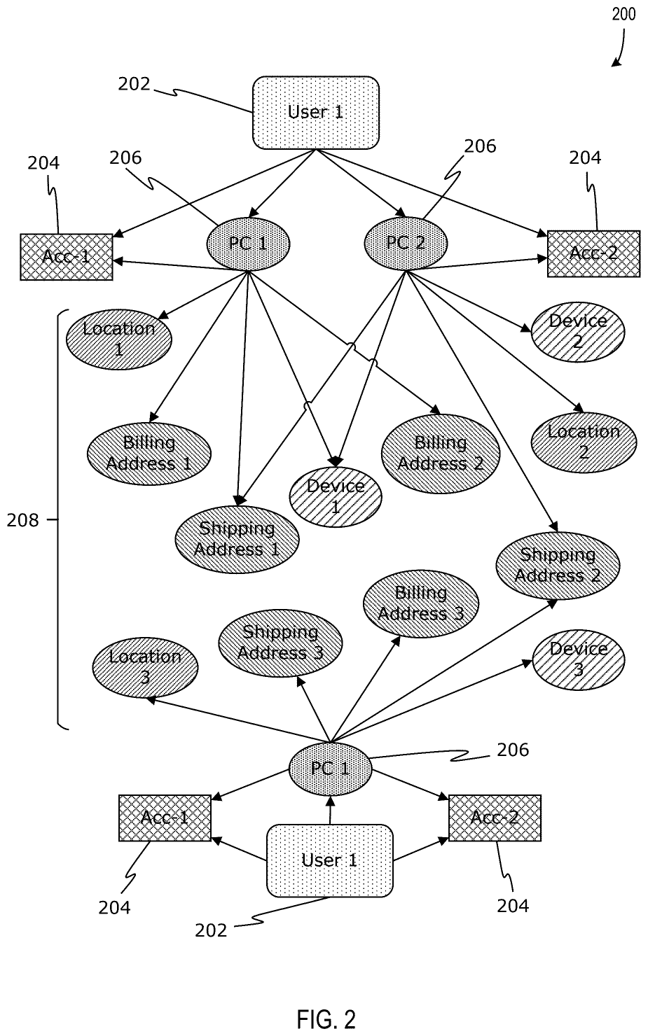

In some examples, the payment account information 122 and cardholder information 124 associated with the records 110 are used to generate or form a network 200 of payment types 112, such as the network 200 of cards associated with a user 202 as illustrated in FIG. 2 or multiple users (not shown). As described in more detail herein, cards are determined to have different levels of relationships belonging or associated with the same user, friends and family, same locality, etc. This “intelligence” is obtained in some examples by forming the network 200 of cards using the data corresponding to the data fields 132 (e.g., using 3DS2 data fields). As can be seen, relationships (illustrated by the arrows) between accounts 204 and payment cards 206 for the user 202 are identified using data 208, which is obtained from the data fields 132 in various examples.

Thus, in various examples, a network for payment cards with different entities can be formed. For example, one or more of the following networks can be formed (or extracted) to produce meaningful insights for digital identity of the cardholder: payment card—account network, payment card—device network, payment card—billing address network, and payment card—location network, among others.

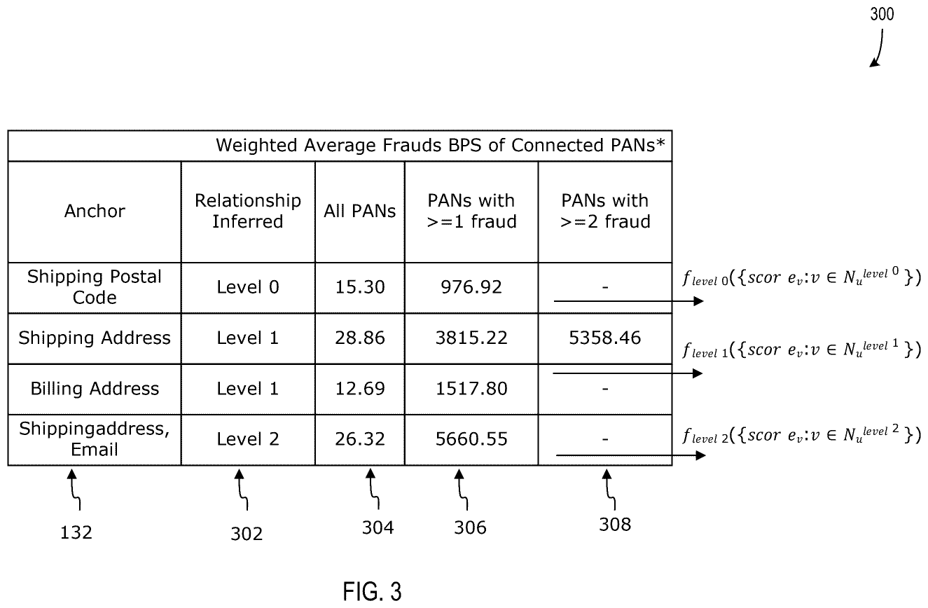

An example of a connected fraud risk determined using one or more the networks is shown in FIG. 3. As can be seen in the table 300, a plurality of data fields 132 are used to determine a level 302 of the relationships as described in more detail herein. In the example, the table 300 correspond to a connected fraud risk that represents a weighted average fraud basis points (BPS) of connected permanent account numbers (PANs), wherein weighted values are computed as: (Total fraud transactions)/(Total approved transactions). The table 300 shows a score 304 for all PANs, a score 306 for PANs with a fraud of greater than or equal to a level 1 relationship and a score 308 for PANs with a fraud of greater than or equal to a level 2 relationship.

In this example, the overall fraud BPS is calculated as 4.29 based on the formula below:

$${f}_{-} , {f}_{-} ( level 0 ) , {f}_{-} ( level 1 ) , {f}_{-} ( level 2 ) = WeightedMean ( . )$$

For this example, the score of all nodes is initialized as the corresponding fraud BPS and the following is used:

$$Fraud BPS = 10000 * ( fraud count ) / ( Fraud count + non - fraud count )$$

As can be seen, the table 300 shows that scores for fraudulent cards (>1 fraud transaction) have a high magnitude and can be separated by thresholding (e.g., score>100). It should be noted that in various examples filters are used in the connected fraud risk analysis represented by the table 300 as follows: (1) 2<=Number of PANs for shipping address<=25 and (2) number of merchants for shipping address>2.

Thus, various aspects described herein use transaction data 106, including records 110 having one or more data fields 132 (e.g., data fields corresponding to 3DS2 data) to establish relationships between different payments cards and/or payment accounts using multiple levels of granularity. In some aspects, task-specific scoring is used to generate scores for downstream applications.

In some examples, the results and/or analysis from the relationship manager 104 are output to a user via a user interface device 150. For example, the determined relationships or scores are presented to the user as a graphical representation 152, such as an icon, graph, table, chart, or other graphical representation. In other examples, one or more report(s) 154 are generated including results in textual form and/or graphical form. The report(s) 154 can optionally include an audio component, such as audio describing data, relationships, scores, etc. In still other examples, one or more prediction(s) 156 are generated and displayed. For example, the threshold value as described in more detail herein is dynamically set based on whether or not fraud occurred after the one or more prediction(s) 156 in some implementations.

In some examples, based on the connected fraud risk analysis, a fraud mitigation action is performed, or caused to be performed. Example fraud mitigation actions include, but are not limited to, blocking a future transaction, sending an alert to a cardholder, freezing a card or account, automatically applying a higher level of authentication to a card or account (e.g., instituting two-factor authentication), flagging a card or account for manual review, training or updating a machine learning model used for fraud analysis, or a combination thereof.

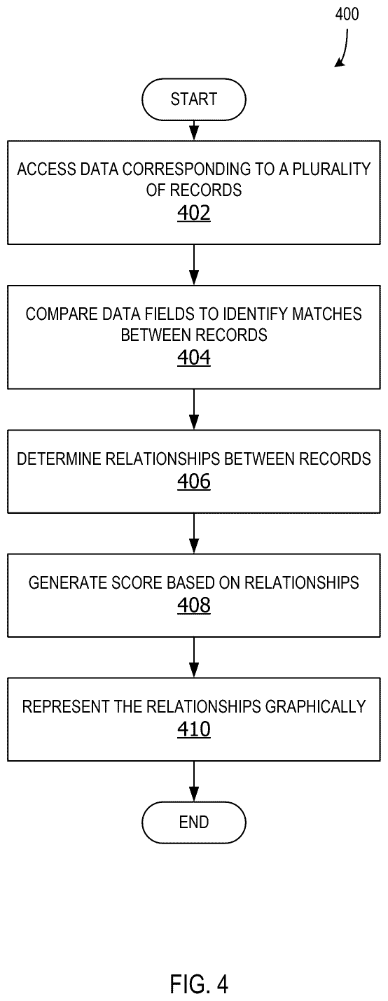

FIG. 4 is an exemplary flow chart 400 illustrating operations of the computing device 102 to identify relationships between records (e.g., the records 110). The process shown in FIG. 4 is implemented by the relationship manager 104 executing on a computing device, such as, but not limited to, the computing device 102 in FIG. 1.

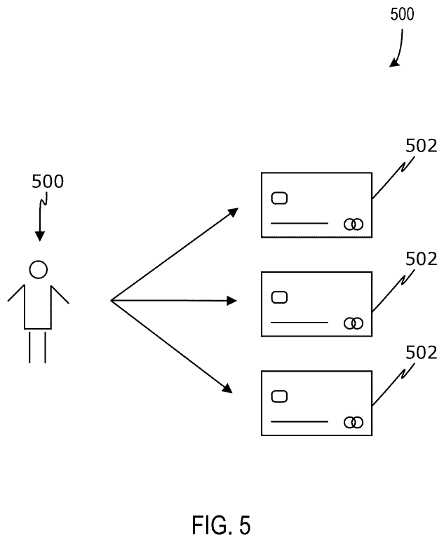

The process begins with accessing data corresponding to a plurality of records at 402. For example, the relationship manager 104 accesses data related to different consumer cards, such as the different records 110 having associated record data 120. As should be appreciated, a single cardholder 500 can use multiple consumer cards 502 as illustrated in FIG. 5. That is, the single cardholder 500 can use different consumer cards 502 at different times, at different locations, etc.

The relationship manager 104 compares data fields of the data (e.g., data corresponding to the consumer cards 502) to identify one or more matches between the plurality of records at 404. For example, the relationship manager 104 identifies one or more matches using data corresponding to the data fields 132, wherein the one or more matches comprises a locality match, a shipping address match, an email match, a device match, or a combination thereof as described in more detail herein. As should be appreciated, other matches can be used.

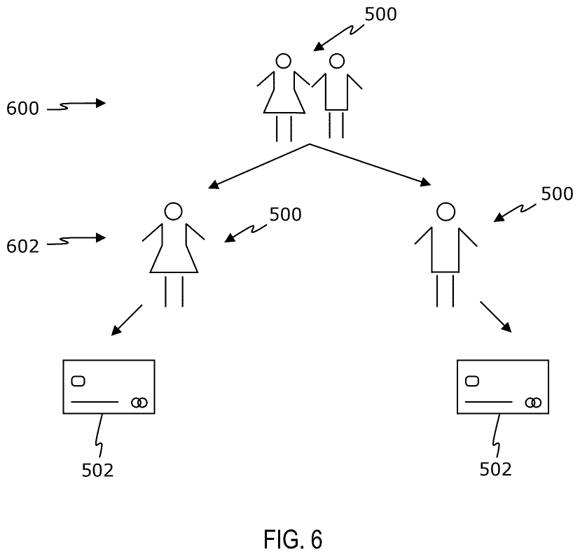

The relationship manager 104 determines a plurality of relationships between the plurality of records at 406 based at least on the identified one or more matches. That is, one or more relationships based on data from the records 110 are identified based on data fields 132 having the same or similar data. In some examples, the comparison identifies any data fields 132 having data that is related and includes the same or similar content (e.g., same billing address or device in the same location or a surrounding area). In some examples, criteria associated with a plurality of relationship levels associated with the plurality of relationships is defined. For example, users of cards, such as the cardholder 500 using the consumer cards 502, can be related on various levels 600, 602 as illustrated in FIG. 6.

The relationship manager 104 generates a score based on the determined plurality of relationships at 408. For example, a score for a particular task (e.g., fraud risk analysis) is generated using the determined relationships. As described in more detail herein, the score in some examples represents a task specific score where the task can be different credit analysis or transaction analysis tasks, such as, fraud risk, return risk, affluence scoring, etc. In some examples, the score is compared to a threshold value corresponding to a risk level to determine one or more actions to be performed. The threshold value in one example is dynamically set based on an event (e.g., fraud detection) occurring after a prediction (e.g., fraud action) based on the threshold value. In some examples, the score is transmitted to a downstream application for further analysis or processing, such as transmitted to a learnable model to determine the threshold value or to perform further processing.

The relationship manager 104 generates a graphical representation of the relationship at 410. For example, the determined plurality of relationships is displayed as icons associated with the plurality of records via the user interface device 150. In some examples, the size of the icons, spacing between the icons, etc., are varied based on the level of the relationship, the score, etc. It should be appreciated that any graphical representation of the relationship or other data can be presented to the user, such as graphical representations illustrating the network 200 (shown in FIG. 2), wherein the arrows and nodes can be made interactive, such that clicking on the graphical representations (e.g., user clicking on the nodes) allows the user to view information at the account level and/or the merchant level. In some examples, the icons are automatically moved or sized relative to each other based on at least one of the determined plurality of relationships and the score. The process terminates thereafter.

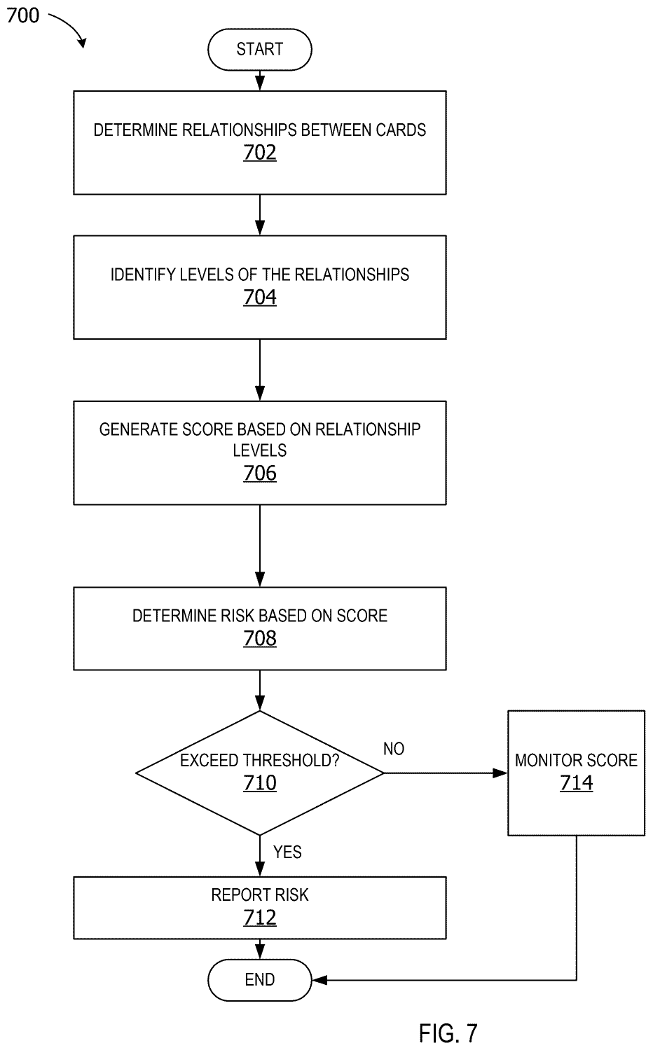

FIG. 7 is an exemplary flow chart 700 illustrating operations of the computing device to monitor for risk (e.g., credit card fraud risk). The process shown in FIG. 7 is implemented by the relationship manager 104 executing on a computing device, such as, but not limited to, the computing device 102 in FIG. 1.

The process begins with the relationship manager 104 determining relationships between cards at 702. For example, as described in more detail herein, relationships between different consumer cards are determined by comparing data between a plurality of records associated with the consumer cards. It should be noted that the consumer cards in some examples are consumer payment cards that may be of different types and that can be associated with one or more individuals (e.g., a group of individuals, such as a family). The relationships in some examples are determined by matching data fields of the data that are compared, such as to identify a locality match, a shipping address match, an email match, and/or a device match, among others.

The relationship manager 104 identifies levels of the relationships at 704. For example, one or more levels are defined based on a number of data fields that match between records associated with the consumer cards. The levels in some examples correspond to a likelihood of an inferred relationship.

The relationship manager 104 generates a score based on the relationship levels at 706. In some examples, as described herein, the score is a task specific score that relates to a risk analysis or determination. That is, the score in some examples corresponds to a likelihood of a particular type of risk. In some examples, the relationship manager 104 determines risk based on the score at 708. For example, based on the score, the relationship manager 104 computes or determines a risk level (which may include a risk profile) associated with the score. The risk level in some examples is determined based on historical data, machine learning, artificial intelligence, etc. That is, the score is used to identify the level of risk for the particular task (e.g., potential for fraud).

The relationship manager 104 determines whether the risk level exceeds a threshold at 710. For example, a determination is made as to whether the risk is an acceptable risk based on a defined threshold value or criteria. If the threshold is not exceeded, then the risk and/or score continues to be monitored at 714. For example, the score can change as data is updated and the updated score is monitored, such as relative to the threshold. As an example, fraud risk continues to be monitored, which may include providing information for downstream fraud detection models.

If the threshold is exceeded, then the risk is reported at 712. That is, a notification or alert of an unacceptable risk level is provided and subsequent action to reduce the risk level can be performed. In some examples, in response to the reported risk, predictions for future risk are made as described herein and used to dynamically adjust the threshold. The process terminates thereafter.

Thus, various aspects determine relationships between different records, such as associated with payment cards or payment accounts, and uses the relationships to identify risks. In some examples, scores are generated that can be used by downstream applications (e.g., fraud detection applications).

### ADDITIONAL EXAMPLES

In an example application of the disclosure as described herein, a downstream application, for example a machine learning component (e.g., a support vector machine) is trained using labeled samples of historical data of relationship scores. For example, the labeled data used for training includes relationship score values and corresponding probability value of each sample being a sample representing a fraudulent transaction. The incoming data of current relationship score values is input to the trained machine learning component to predict a probability that the incoming relationship scores represent fraudulent transactions. The output of the incoming data is classified into different severity levels using the operations described herein. In this example, a probability value less than 0.2 is designated as low risk. A probability value between 0.2 and 0.4 signals a general risk. A probability value between 0.4 and 0.6 signals a significant risk. A probability value between 0.6 and 0.8 signals a high risk. A probability value above 0.8 signals a severe risk. One or more example mitigation actions, as discussed herein, are taken based on the severity of the fraudulent transaction. It will be understood that other ranges of probability values can be chosen without departing from the example scenario subject matter.

In another example scenario, a relationship score based on location of restaurants and dining out spend patterns of persons living in a relatively high-end housing society are determined. The affluence scores are calculated based on a quantum of spend at restaurants and input to a downstream trained machine learning model (e.g., neural pattern recognition model) to recognize patterns of spend at different locations in a locality. In this example, the recognized pattern data shows a greater inclination towards a selection of restaurants in the locality. This data is used to send mailers to those residents that do not visit the selection of restaurants to spur them to visit these restaurants. Various other actions may be taken based on the output of the trained machine learning model to propagate the popularity of restaurants in the locality.

As another example scenario, a father gives an add-on credit card to his son who is proceeding for his graduate studies to live in a hostel, situated in an area far away from the residence of the father. Relationship scores, as described herein, are regularly calculated on the total spend of the father's credit card and the add-on card, based on a common billing address. These relationship scores are transmitted to a downstream machine learning component (e.g., a neural network) trained to detect patterns in incoming data. A few months later, in the company of his new friends, the son becomes a profligate spender on the credit card provided by his father. At this point, the machine learning model detects very different patterns in the relationship score data bordering on a bust-out risk, compared to historical patterns of spending. The issuer of the credit cards issued to the father and son is informed of this situation to take appropriate action.

### Exemplary Operating Environment

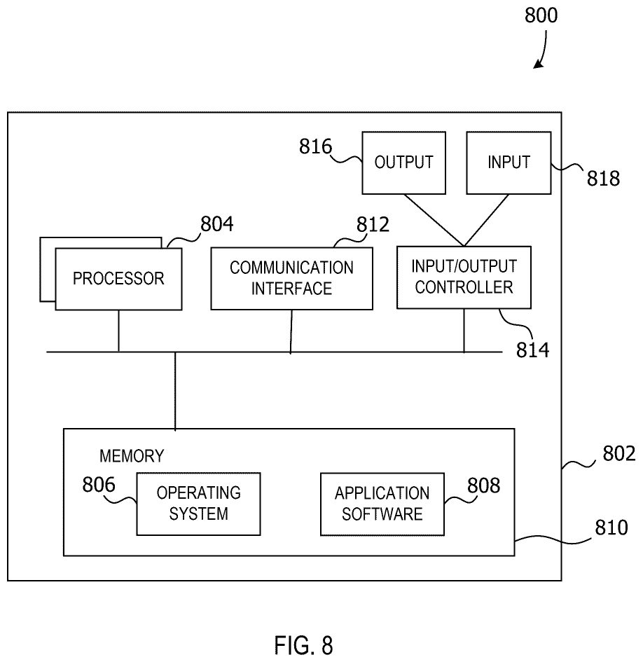

The present disclosure is operable with a computing apparatus according to an embodiment as a functional block diagram of a computing system 800 in FIG. 8. In an embodiment, components of a computing apparatus 802 may be implemented as a part of an electronic device according to one or more embodiments described in this specification. The computing apparatus 802 comprises one or more processors 804 which may be microprocessors, controllers, or any other suitable type of processors for processing computer executable instructions to control the operation of the electronic device. Alternatively, or in addition, the processor 804 is any technology capable of executing logic or instructions, such as a hardcoded machine. Platform software comprising an operating system 806 or any other suitable platform software may be provided on the apparatus 802 to enable application software 808 to be executed on the device.

Computer executable instructions may be provided using any computer-readable media that are accessible by the computing apparatus 802. Computer-readable media may include, for example, computer storage media such as a memory 810 and communications media. Computer storage media, such as the memory 810, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals are not examples of computer storage media. Although the computer storage medium (the memory 810) is shown within the computing apparatus 802, it will be appreciated by a person skilled in the art that the storage may be distributed or located remotely and accessed via a network or other communication link (e.g., using a communication interface 812).

The computing apparatus 802 may comprise an input/output controller 814 configured to output information to one or more output devices 816, for example a display or a speaker, which may be separate from or integral to the electronic device. The input/output controller 814 may also be configured to receive and process an input from one or more input devices 818, for example, a keyboard, a microphone, or a touchpad. In one embodiment, the output device 816 may also act as the input device. An example of such a device may be a touch sensitive display. The input/output controller 814 may also output data to devices other than the output device, e.g., a locally connected printing device. In some embodiments, a user may provide input to the input device(s) 818 and/or receive output from the output device(s) 816.

The functionality described herein can be performed, at least in part, by one or more hardware logic components. According to an embodiment, the computing apparatus 802 is configured by the program code when executed by the processor 804 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example computer system comprises: a data storage device storing data corresponding to a plurality of records, the data related to different consumer cards; and a computer-readable medium storing instructions that are operative upon execution by a processor to: access the data stored in the data storage device; compare data fields of the data to identify one or more matches between the plurality of records, wherein the one or more matches comprises a locality match, a shipping address match, an email match, a device match, or a combination thereof; determine a plurality of relationships between the plurality of records based at least on the identified one or more matches; generate a score based on the determined plurality of relationships; represent the determined plurality of relationships with icons associated with the plurality of records; and automatically move the icons relative to each other based on at least one of the determined plurality of relationships and the score.

A computer-implemented method for identifying relationships between records comprises accessing data corresponding to a plurality of records, the data related to different payment cards or different payment accounts; comparing data fields of the data to identify one or more matches between the plurality of records; determining a plurality of relationships between the plurality of records based at least on the identified one or more matches; analyzing the determined plurality of relationships for a connected fraud risk; and performing a fraud mitigation action based on the analyzing.

One or more exemplary non-transitory computer readable storage media comprise computer-executable instructions for identifying relationships between records that, upon execution by a processor, cause the processor to perform operations comprising: accessing data corresponding to a plurality of records, the data related to different consumer cards; comparing data fields of the data to identify one or more matches between the plurality of records, wherein the one or more matches comprises a locality match, a shipping address match, an email match, a device match, or a combination thereof; determining a plurality of relationships between the plurality of records based at least on the identified one or more matches; generating a score based on the determined plurality of relationships; representing the determined plurality of relationships with icons associated with the plurality of records; and automatically moving the icons relative to each other based on at least one of the determined plurality of relationships and the score.

In some examples, the system provides a novel approach to establish relationships between records, such as for payment cards and/or payment accounts by comparing data fields of the records, and then generating scores that can be used for downstream applications. In other words, the system identifies relationships between records that are otherwise not available.

Alternatively, or in addition to the other examples described herein, examples include any combination of the following:
define criteria associated with a plurality of relationship levels associated with the plurality of relationships;
use data that comprises 3DS2 data;
use data that corresponds to records for a single user of the plurality of cards;
use data that corresponds to records for multiple users of the plurality of cards;
generate a score that relates to a task corresponding to at least one of a fraud risk, a return risk, an affluence score, a credit bust-out risk, leaked card reporting, or a loyalty program;
transmit the score to a downstream application;
compare the score to a threshold value corresponding to a risk level;
dynamically set the threshold value based on a fraud detection occurring after a prediction;
transmit the score to a learnable model to determine the threshold value; and
provide a user interface device generate a graphical representation of a network of cards based on the determined plurality of relationships, wherein the graphical representation includes the icons.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for accessing data corresponding to a plurality of records, the data related to different consumer cards; exemplary means for comparing data fields of the data to identify one or more matches between the plurality of records, wherein the one or more matches comprises a locality match, a shipping address match, an email match, a device match, or a combination thereof; exemplary means for determining a plurality of relationships between the plurality of records based at least on the identified one or more matches; exemplary means for generating a score based on the determined plurality of relationships; exemplary means for representing the determined plurality of relationships with icons associated with the plurality of records; and exemplary means for automatically moving the icons relative to each other based on at least one of the determined plurality of relationships and the score.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system operable to identify relationships between records, the system comprising:
a data storage device storing data corresponding to a plurality of records, the data related to different consumer cards; and
a computer-readable medium storing instructions that are operative upon execution by a processor to:
access the data stored in the data storage device;
compare data fields of the data to identify one or more matches between the plurality of records, wherein the one or more matches comprises a locality match, a shipping address match, an email match, a device match, or a combination thereof;
determine a plurality of relationships between the plurality of records based at least on the identified one or more matches;
generate a score based on the determined plurality of relationships;
represent the determined plurality of relationships with icons associated with the plurality of records; and
automatically move the icons relative to each other, in a user interface, based on at least one of the determined plurality of relationships and the score.

2. The system of claim 1, wherein the instructions are further operative to:
define criteria associated with a plurality of relationship levels associated with the plurality of relationships.

3. The system of claim 1, wherein the data comprises 3DS2 data.

4. The system of claim 1, wherein the data corresponds to the plurality of records for a single user of the different consumer cards.

5. The system of claim 1, wherein the data corresponds to the plurality of records for multiple users of the different consumer cards.

6. The system of claim 1, wherein the score relates to a task corresponding to at least one of a fraud risk, a return risk, an affluence score, a credit bust-out risk, leaked card reporting, or a loyalty program.

7. The system of claim 1, wherein the instructions are further operative to:
transmit the score to a downstream application.

8. The system of claim 1, wherein the instructions are further operative to:
compare the score to a threshold value corresponding to a risk level.

9. The system of claim 8, wherein the instructions are further operative to:
dynamically set the threshold value based on a fraud detection occurring after a prediction.

10. The system of claim 8, wherein the instructions are further operative to:
transmit the score to a learnable model to determine the threshold value.

11. The system of claim 8, further comprising:
a user interface device, wherein the instructions are further operative to:
generate a graphical representation of a network of cards based on the determined plurality of relationships, wherein the graphical representation includes the icons.

12. A computer-implemented method for identifying relationships between records, the method comprising:
accessing data corresponding to a plurality of records, the data related to different payment cards or different payment accounts;
comparing data fields of the data to identify one or more matches between the plurality of records;
determining a plurality of relationships between the plurality of records based at least on the identified one or more matches;
analyzing the determined plurality of relationships for a connected fraud risk; and
performing a fraud mitigation action based on the analyzing.

13. The computer-implemented method of claim 12, further comprising defining criteria associated with a plurality of relationship levels associated with the plurality of relationships.

14. The computer-implemented method of claim 13, wherein the data comprises 3DS2 data.

15. The computer-implemented method of claim 13, wherein the one or more relationships are determined using a locality match, a shipping address match, an email match, a device match, or a combination thereof.

16. The computer-implemented method of claim 13, wherein the data corresponds to records for a single user of the different payment cards or the different payment accounts.

17. The computer-implemented method of claim 13, wherein the data corresponds to records for multiple users of the different payment cards or the different payment accounts.

18. The computer-implemented method of claim 13, further comprising:
generating a score based on the determined plurality of relationships, wherein the score relates to a task corresponding to at least one of a fraud risk, a return risk, an affluence score, a credit bust-out risk, leaked card reporting, or a loyalty program.

19. The computer-implemented method of claim 18, further comprising:
transmitting the score to a downstream application.

20. One or more computer storage devices having computer-executable instructions stored thereon, which, upon execution by a computer, cause the computer to perform operations comprising:
accessing data corresponding to a plurality of records, the data related to different consumer cards;
comparing data fields of the data to identify one or more matches between the plurality of records, wherein the one or more matches comprises a locality match, a shipping address match, an email match, a device match, or a combination thereof;
determining a plurality of relationships between the plurality of records based at least on the identified one or more matches;
generating a score based on the determined plurality of relationships;
representing the determined plurality of relationships with icons associated with the plurality of records; and
automatically moving the icons relative to each other, in a user interface, based on at least one of the determined plurality of relationships and the score.
